(19) United States
(12) Patent Application Publication
(10) Pub. No.: US 2003/0236685 A1
(43) Pub. Date: Dec. 25, 2003

(54) Preferred life mortality systems and methods

(76) Inventors: Robert Buckner, Kansas City, MO (US); Sampath Damodarasamy, Overland Park, KS (US); Charles Thomas, Lee's Summit, MO (US)

Correspondence Address: LATHROP & GAGE LC, 2345 GRAND AVENUE, SUITE 2800, KANSAS CITY, MO, 64108, US

(21) Appl. No.: 10/174,643

(22) Filed: Jun. 19, 2002

(51) Int. Cl. G06F 17/60

(52) U.S. Cl. 705/4

(57) ABSTRACT

The invention provides systems and methods for determining preferred life mortality analyses. Mortality data is electronically synthesized from a plurality of insurance carriers. A data engine processes the mortality data and synthesizes benchmark data to present the analyses, preferably in graphical form such as a data cube. User inputs at remote computers provide access to secure data in the database; these inputs may request the analyses relative to one or more preferred life risk scenarios, such as age, height, weight, gender, blood pressure, cholesterol, familial cancer history, familiar history of heart attack, familial history of stroke, smoker or non-smoker status, and smoking history. The analyses may assist in assessing appropriate monetary reserves for an insurance carrier, and/or pricing for insurance products.

### BACKGROUND OF THE INVENTION

Current insurance practices segment insureds into refined or preferred classes of risk but do not link these segments to actuarial data in support of pricing and loss reserves. Accordingly, the pricing and loss reserves associated with insurance products ineffectively predict expected losses and instead rely on outmoded and isolated data available to the associated insurance carrier.

### SUMMARY OF THE INVENTION

The invention seeks to advance the state of the art of insurance products by providing methods and systems to accurately analyze mortality and risk persistency. One feature of the invention is to synthesize mortality data from multiple insurance carriers to improve risk prediction and credibility. Several other features of the invention are apparent within the description that follows.

By way of example, the invention may provide a system for determining preferred life mortality based upon factual policy-level demographic data of individual insured lives from multiple insurance carriers. This data is normalized for one or more classifications of risk and then stored in a secure database. The normalization facilitates subsequent comparisons and analyses of the data, such as a comparison of the normalized data to actuarial benchmark tables. Accordingly, an authorized user at a computer networked with the database may access and command such comparisons and analyses to investigate insurance product pricing and/or the amount of reserves required for a particular classification of risk. Since the data is synthesized from multiple insurance carriers, a particular insurance company can compare its products and pricing to other insurance carriers. A web platform may provide the interface to the secure database so that authorized users may access the system remotely. These users may for example input data from a plurality of preferred life risk scenarios, including age, height, weight, blood pressure, cholesterol, familial cancer history, familial history of heart attack, gender, familial history of stroke, smoker or non-smoker status, and smoking history.

In certain aspects, the invention provides methods and systems for analyzing the mortality and persistency experience of insured lives based on policy data and claim data supplied by multiple insurance carriers. The data preferably includes information about multiple deaths of prior insured persons over a period of years. These methods and systems may further determine the adequacy of pricing and reserves to facilitate and enhance insurance products and reporting to regulatory bodies. In one aspect, the invention substantiates the amount and adequacy of insurance reserves based upon an insurance carrier's portfolio of preferred risks, thereby circumventing regulatory requirements to set rates based upon older, standardized classes of risk.

In another aspect, the invention utilizes a data set covering multiple deaths over a predetermined period of time in order to provide sufficient verification for calculations supporting the new insurance products.

In yet another aspect, the invention provides a web platform that facilitates interactive analysis of preferred life risk scenarios in supporting pricing and reserve policies for insurance carriers.

In still another aspect, certain systems and methods of the invention utilize a secure relational database that stores policy-level demographics about individual insured lives, including the classification of the risk by insurance carrier.

In one aspect, the database includes industry standard benchmark tables. In another aspect, a software application transforms and aggregates data so as to provide a graphical, convenient forum to view, modify and analyze mortality and persistence data according to various scenarios, including benchmark calculations using the benchmark tables. In one aspect, the data is transformed into a datastore or “cube.” Analytical tools coupled with the software application may provide a graphic user interface so as to view the data from various aspects of measures and dimensions, by selecting values with a mouse or other computer pointing device. Benchmark calculations can include a percentage allocation relative to a well-known expectation or actuarial table, for example the 1975-1980 SOA mortality table, the 1980 CSO valuation table, and/or foreign country (e.g., UK, Germany) actuarial tables.

A computer connected to the web platform and/or database may for example provide the interactive mechanism to manipulate the system and perform calculations. In another example, certain of the above-referenced analytical tools may be enabled via a web browser.

In another aspect, the invention provides a method for synthesizing mortality data. A plurality of insurance carriers periodically submit policies, in bulk, to a central depository or database. A software application synthesizes the data from the policies to track, over time, the mortality experiences for different classes of policies. By way of example, one class may be the smoking class while another is the non-smoking classes. Other classes may for example include factors such as cholesterol, blood pressure, weight, height, age, and familial history of cancer, heart attack and stroke.

In one aspect, the software application provides a variety of options for user-selected and flexible analysis of insurance policy data within the database. The software application and/or analytical tools may for example include, or interface with, a COGNOS interface known in the art. In one aspect, the software application synthesizes data to generate mortality experience charts to predict appropriate pricing data for new insurance products. The database may be protected, i.e., “secured,” to ensure privacy of stored information, accessible to only persons with authorized access codes. The software application may further compare policies across multiple insurance carriers and insurance claims relative to one or more classes of insureds.

In other aspects, the invention provides methods and systems for (a) analyzing mortality data to verify pricing for insurance products, (b) establishing carrier liability through mortality experience studies, for example to offset reserve requirements, and/or (c) comparing policy, claim and/or mortality experience data against the generalized insurance industry to benchmark a carrier's practices against that industry. By way of example, and with respect to (c), a carrier may use the system to review insurance products sold and priced to male and female customers as compared to gender averages for the industry. A similar comparison may be made, for example, with respect to plan type, such as ten years versus twenty years.

In still another aspect, systems and methods of the invention may assess mortality expectations of an insured relative to a certain percentage of pre-existing actuarial tables. Accordingly, such systems and methods may provide real-time assessments of how the insured will fare relative to, for example, 85% to 90% of similarly insured persons in the past.

Analyses provided through methods and systems of the invention may thus assist insurance carriers in properly pricing insurance products and/or in establishing proper financial reserves. Another advantage is that such insurance companies may quantitatively assess individual insurance products against industry-wide products, so as to provide better or more refined services. Other advantages and features of the invention should be apparent within the description herein.

The invention is next described further in connection with certain embodiments, and it will become apparent that various additions, subtractions, and modifications can be made by those skilled in the art without departing from the scope of the invention.

### BRIEF DESCRIPTION OF THE DRAWINGS

A more complete understanding of the invention may be obtained by reference to the drawings, in which:

FIG. 1 shows one preferred life mortality system of the invention;

FIG. 2 shows a data flow engine for collating and sorting mortality data in accord with one method of the invention;

FIG. 3 shows a flowchart illustrating one method for analyzing mortality data in accord with the invention; and

FIG. 4-FIG. 9 show illustrative charts that may be generated through the system and method of FIG. 1 and FIG. 3, respectively.

### DETAILED DESCRIPTION OF THE DRAWINGS

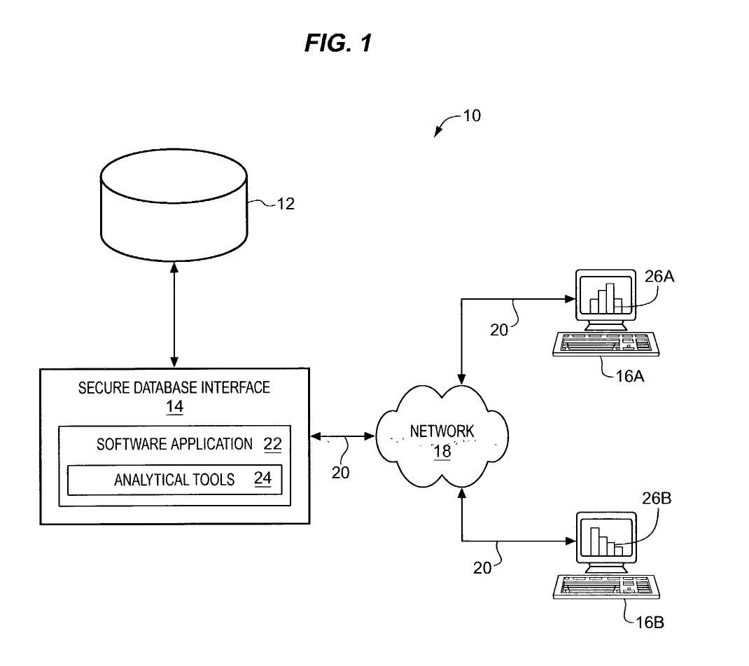

FIG. 1 shows one system 10 of the invention. System 10 includes a relational database 12 communicatively connected to a secure database interface 14. One or more computers 16A, 16B connect to interface 14 via a network 18 so as to access, analyze and/or report information of database 12. One or more of computers 16A, 16B may also download information, such as mortality experience data, to database 12 so as to augment future uses of that information. In one example, interface 14 is a web platform that facilitates interactive analysis of preferred life mortality scenarios based on data within database 12 and in support of pricing and reserve policies.

Network 18 may represent the Internet and/or a local area network. Computers 16 may thus be configured for accessing interface 14 and database 12 via network 18. The connection 20 between computers 16 and interface 14 may be Virtual Private Network or other secure data link. Those skilled in the art should appreciate that interface 14 and database 12 may form a monolithic or distributed database architecture without departing from the scope of the invention.

Interface 14 may include application software 22 to provide functionality for certain systems and methods described herein. By way of example, application software 22 may be configured to view, modify and analyze mortality and persistence data within database 12 for one or more user-selected scenarios, such as comparing a particular individual or class to benchmark and/or actuarial data. Application software 22 may for example convert database information into a data cube, as described in more detail below. In one embodiment, application software 22 includes one or more analytical tools 24 to provide a graphical user interface between users at computers 16 and data within database 12.

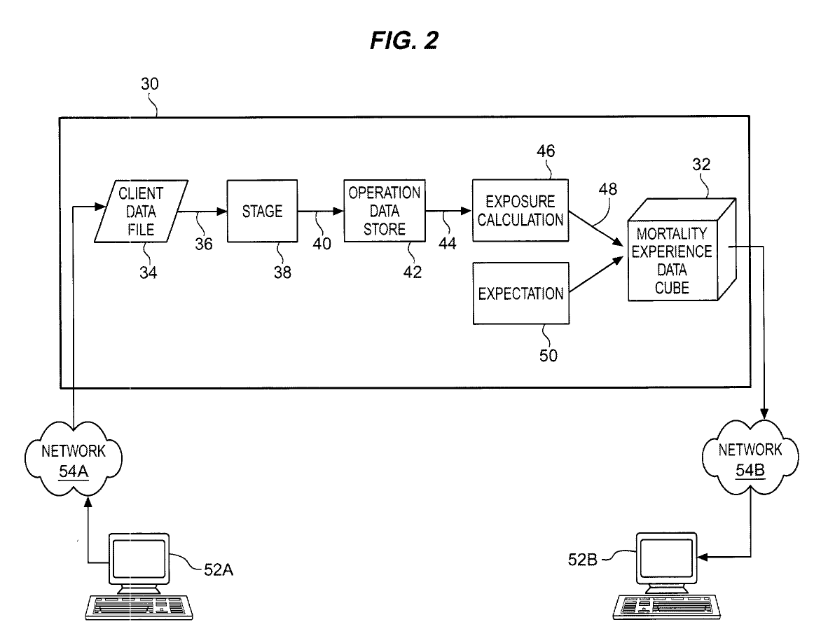

Secure database interface 14 may restrict user access and/or download of data to database 12 by one of several known techniques. By way of one exemplary operation, therefore, an authorized user at computer 16A may download proprietary insurance policy information 26A to database 12 via interface 14; another authorized user at computer 16B may then request a synthesis of data within database 12, including information 26A, to generate analytical information 26B. Information 26B may for example include a summary of mortality and persistence data dependent upon certain user-selected scenarios (e.g., a class of persons), benchmark calculations and/or actuarial data, such as described in connection with FIGS. 2-6.

FIG. 2 shows a data flow engine 30 of one embodiment of the invention, for example to produce a data cube 32 presenting information from database 12. In one embodiment, engine 30 facilitates automated entry of new and varied mortality and policy data from a plurality of insurance carriers. Engine 30 may further synthesize the data from the insurance carriers to normalize the data relative to one or more classifications of risk.

More particularly, in process module 34, a client data file is created in response to each automated input of such data. By way of example, such data may be downloaded from an insurance company operating computer 16A to engine 30. Data from process module 34 is transformed and/or validated 36 into stage process module 38. The conversion and/or validation 36 of data from client data file process module 34 to stage process module 38 may include converting files according to certain rules, e.g., business rules, so that data at stage process module 38 is uncorrupted and uniformly formatted; conversion and/or validation 36 may also include (a) discarding or rejecting data, (b) storing data in separate tables for further verification with the client, and (c) correcting data according to certain rules, so that unwanted data does not populate stage process module 38.

A further conversion 40 may occur from stage process module 38 to operation data store process module 42. Conversion 40 may include reformatting, renaming and/or other data conversions so that subsequent process blocks may formulate stored data from engine 30 into data cube 32, for example.

Data from operation data store process module 42 maps 44 into exposure calculations process module 46. Data within exposures calculations process module 46 may for example provide a current status of all current data of engine 30; it may further link all policies to determine risk assessments. Engine 30 transforms 48 data from exposure calculations process module 46 into data cube 32; engine 30 may simultaneously synthesize actuarial data (e.g., mortality data) and/or benchmark calculations from expectation process module 50 and into cube 32. By way of example, expectation process module 50 may include the 1975-1980 reinsurance pricing table, the 1980 CSO valuation table, and/or foreign country (e.g., UK, Germany) actuarial tables.

As noted above, inputs to client data file process module 34 may be downloaded from a computer 52A communicatively connected to module 34 via a network 54A. Data cube 32 may be accessed by a computer 52B communicatively coupled to data cube 32 via a network 54B. In one example, computer 52A may represent computer 26A, FIG. 1; computer 52B may represent computer 26B, FIG. 1; networks 54A, 54B may represent network 18, FIG. 1; and engine 30 may be formulated by interface 14, FIG. 1.

In operation, input data to engine 30 is typically entered periodically (e.g., each month) to client data file process module 34. Since this data can include data such as Cobol data files, transformation 36 may include scrubbing and unpacking that data for input to stage process module 38. In order to assimilate files from different sources, conversion 40 may include renaming and tagging the files by codes to identify, without limitation, the source company, month of data file, year of data file, type of data file and other file or identifying extension. Mapping 44 may thus include periodic (e.g., each twenty minutes) batch processing of data from operation data store process module 38 to formulate data for module 46.

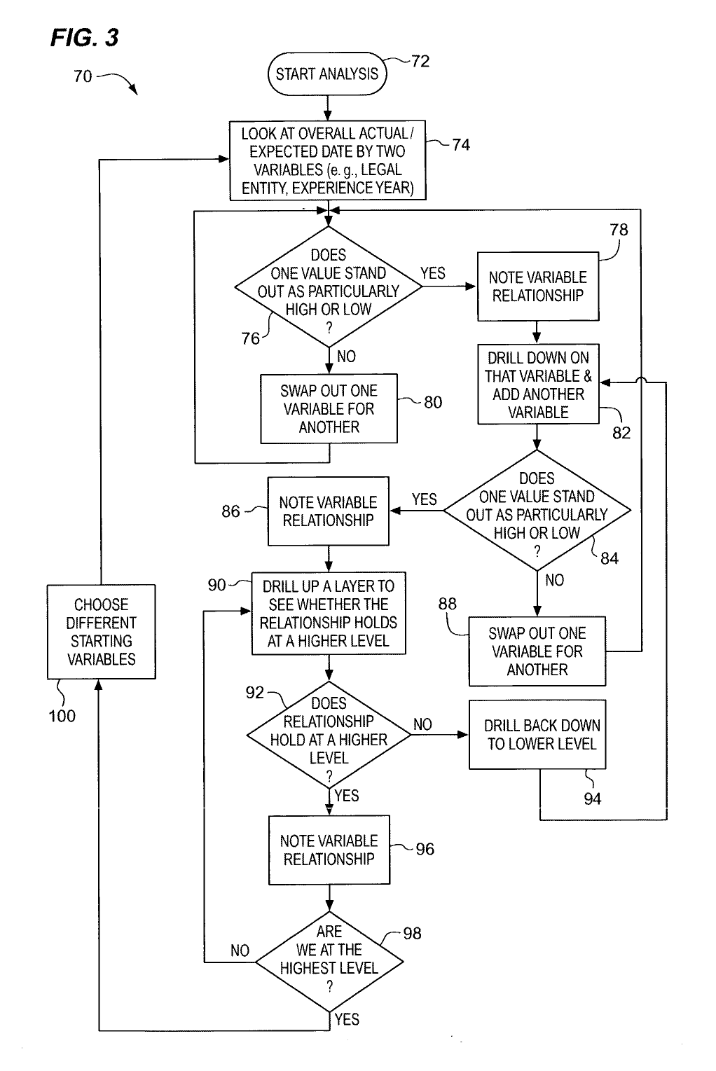

In one embodiment, cube 32 enables the following measured analyses: exposure (in years); expected mortality ((exposure)×(mortality rate)); variance ((exposure)×(mortality rate)×(1−mortality rate)); and a ratio of actual mortality versus expected mortality. Dimensions of the cube can include, for example: study calendar year, gender, issue age, type of underwriting, plan code, generic mortality code, policy duration, issued amount, and benefit amount. These dimensions and measures may be better understood by further clarification of transformation 48 and FIG. 3 below. With regard to transformation 48, the following terminology, parameters and calculations may for example apply:

Study period. Exposure is calculated for each policy per calendar year basis during the study period. As an example, the study period could be set to 5 years with Jan. 1, 1997 as the starting date.

Active and inactive policies. Insurance policies may be inactive or active.

Exposure start-date and exposure end-date. To determine the exposure of a policy, exposure start-date and exposure end-date of that policy is determined.

Start-Date of a policy exposure. If a policy was issued before the start of study period (Jan. 1, 1997), exposure start-date is set to Jan. 1, 1997. Otherwise exposure start-date is set to policy issue date.

End-date of policy exposure. If a policy is active, then exposure end-date is set to the earlier of the date of (a) the most recently received client data or (b) the end of the study period. If a policy is inactive, then exposure end-date is determined by the reason for termination (e.g., lapse, surrender, expiration, recapture). For policies that are inactive due to death, exposure end date is set to next anniversary date, even if the next anniversary date is beyond the study period.

Partial duration of a calendar year. The issue date/anniversary date of a policy splits a calendar year into two durations: from the beginning of year (January 1^{st}) to policy anniversary date (the “first duration”); and from policy issue date/policy anniversary date to end of that year, December 31^{st} (the “second duration”). If the policy is issued on January 1^{st}, then only the first duration is valid. As age may be based on date of birth at issue date, age during the second duration of a calendar year will be greater, by one, than the first duration of that year. The two durations assist in tracking mortality rates based on issue age and duration of policy from the issue age.

Active policy exposure calculations. If a policy is active through an entire calendar year, then exposure (eᵢ) for that calendar year (i) is sum of exposure for the first duration (e_{i,1}) and the second duration (e_{i,2}). Accordingly, eᵢ=e_{i,1}+e_{i,2}, where e_{i,1} and e_{i,2} are defined as follows:

$$\begin{matrix}{e}_{i , 1} = \frac{number of days from Jan 1 st to policy anniversary date}{365} \\ {e}_{i , 2} = \frac{Number of days from policy anniversary \text{/} policy issue date to Dec 31 st}{365}\end{matrix}$$

Since the policy is active in the second duration in the year policy was issued, exposure (eᵢ) for the policy issue calendar year i is given by: eᵢ=e_{i,2}. Exposure calculations for the year in which policy either terminates or becomes inactive depends upon when the termination, inactive point or exposure study ending occurs relative to the first and second durations.

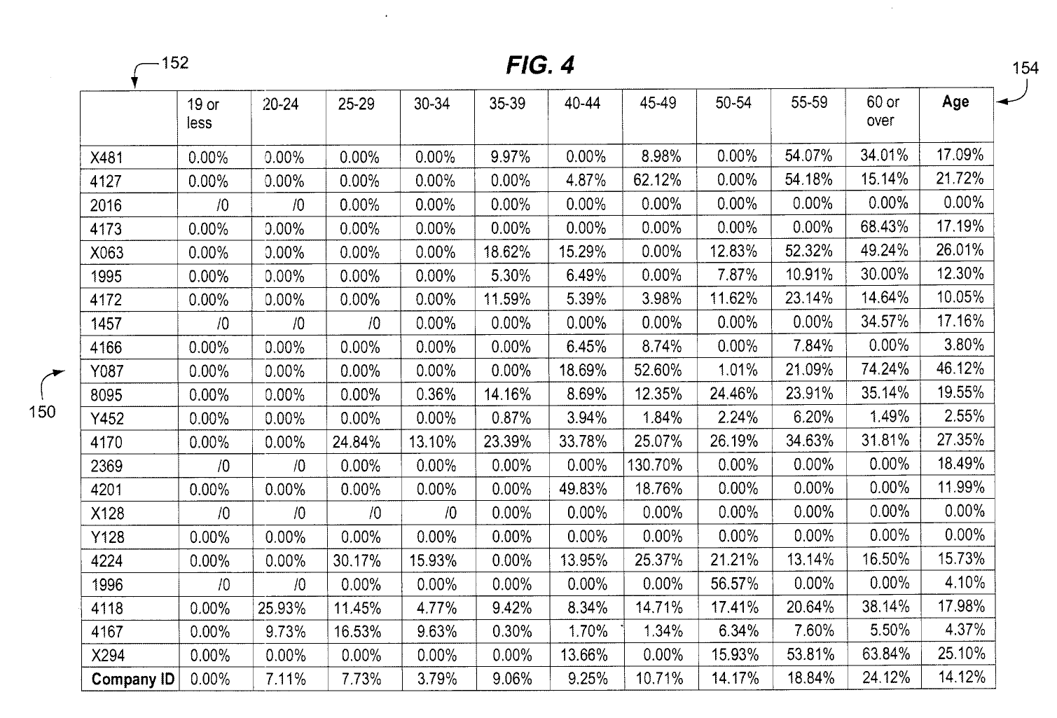

FIG. 3 shows a flowchart illustrating one method 70 for analyzing mortality data in accord with the invention. Method 70 begins at start analysis step 72, for example initiated by request through a computer 16 to interface 14, FIG. 1. At step 74, the data cube (e.g., data cube 32, FIG. 2) presents a graphical and/or tabular view of data upon two variables, such as legal entity and experience year; the data may include mortality, persistence and/or morbidity data. FIG. 4 illustrates one representative view 150 from step 74, showing a table of insurance carriers 152 versus issue age 154. In reviewing view 150, for example, a user of system 10, FIG. 1, may determine 76 that one variable or another stands out as being peculiar or out of normalcy. By way of example, determine step 76 may include searching for a pattern or unusual value in view 150. In one example, and in regard to view 150, FIG. 4, it may be determined 76 that the actual-to-expected percentage appears to increase with age but that, otherwise, variables across company identifier 152 do not present a pattern; accordingly, one may wish to test the hypothesis that actual-to-expected percentage increases with age. The unusual variable relationship is noted 78 so that further analysis may be performed, such as in connection with step 82 described below.

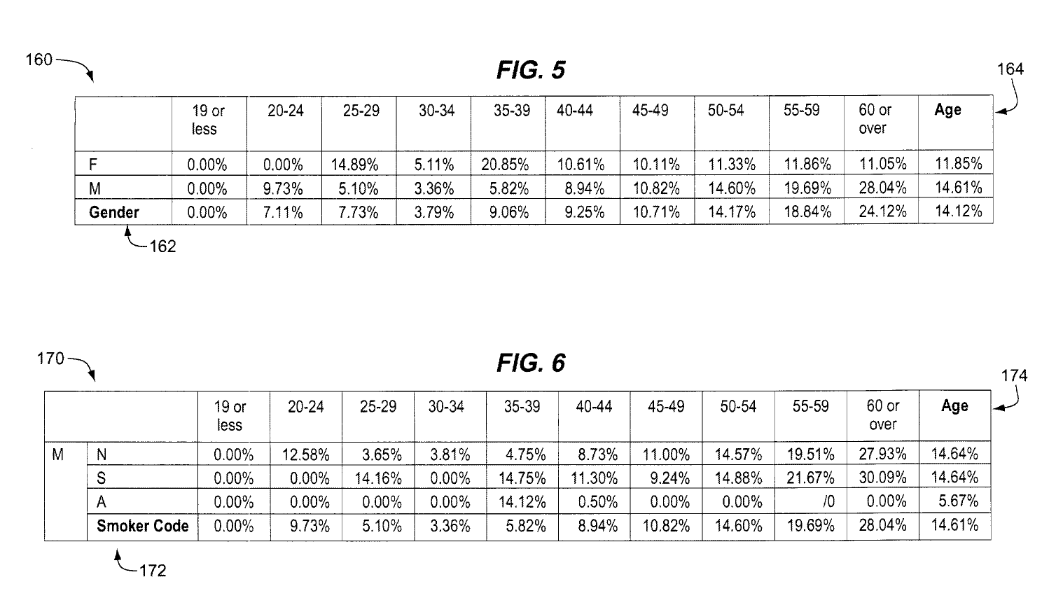

If an unusual relationship is not apparent, other variables may be used in order to study other relationships. By way of example, in step 80 one variable is swapped out for another variable and step 76 is repeated. In one example, company identifier 152 is replaced with gender. FIG. 5 thus illustrates one representative view 160 from step 80, showing a table of gender 162 versus issue age 164. In the illustrated example shown as view 160 in FIG. 5, determine step 76 shows an apparent pattern over increasing age for males versus actual-to-expected percentages; at the same time, determine step 76 does not appear to show any apparent pattern over age for females versus actual-to-expected percentages.

Once again, the variable relationship may be noted 78 for further processing 82. In one example, step 78 includes determining that males seem to exhibit the pattern of increasing actual-to-expected percentage as issue age increases. Accordingly, the data of view 160 may be evaluated further, step 82, to potentially identify lower level causes for the pattern. In particular, step 82 includes a drill down process of incorporating another variable to the data of view 160. By way of example, the data of view 160 may drill down to only males yet with the added variable of smoking. FIG. 6 illustrates one representative view 170 from step 82, showing a table of male smoker status 172 versus issue age 174. In particular, status 172 is shown with smoker codes: “N” for non-smoker, “S” for smoker, and “A” for aggregate?

Similar to step 76, step 84 may determine that one variable or another stands out as being peculiar or out of normalcy. By way of example, determine step 84 may include searching for a pattern or unusual value in view 170, such as whether a particular number appears high or low relative to other numbers. An identified peculiarity is noted 86 similar to step 78 to support further analysis, such as step 90. However with regard to view 170, for example, it appears that both male smokers and male non-smokers exhibit similar patterns of increasing actual-to-expected percentage as age increases.

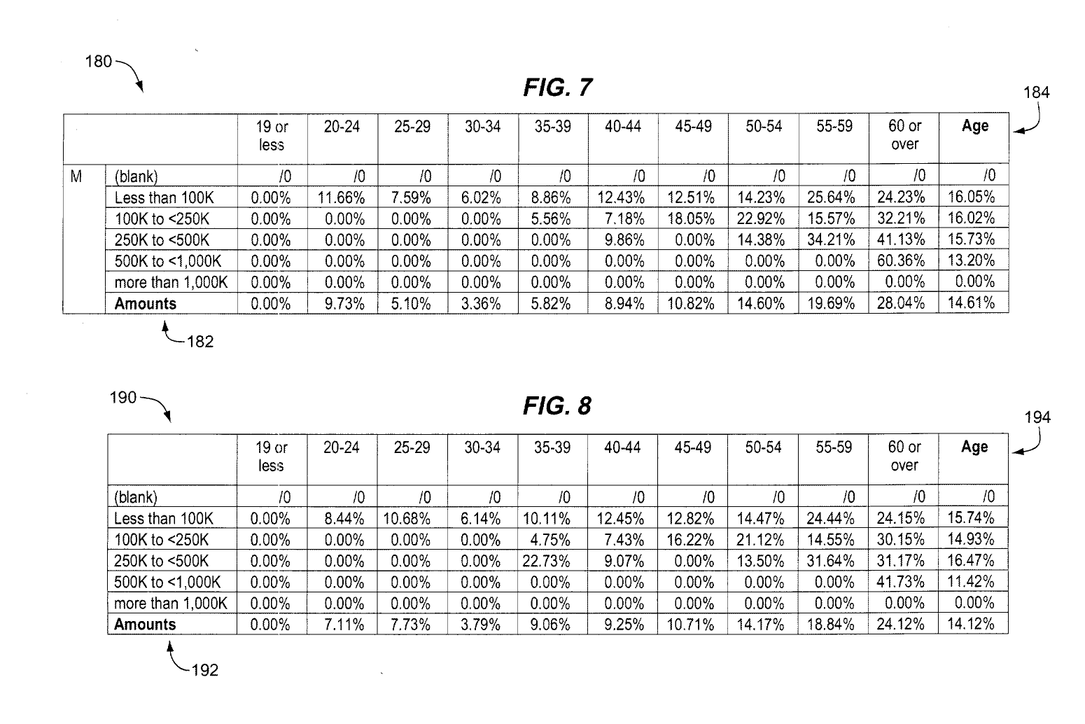

Therefore, similar to step 80, another variable may be used in step 88, wherein one variable is swapped out for another variable and step 82 is repeated. In one example, the smoker status is replaced with a variable indicating policy size. FIG. 7 illustrates one representative view 180 from step 88, showing a table of male policy size 182 versus issue age 184. In view 180, it may be noted 86 that a pattern exists of increasing actual-to-expected percentage as issue age increases. Specifically, the data of view 180 appears accentuated for decreasing policy size; moreover, it appears in view 180 that males have better mortality by increasing policy size.

Accordingly, further drill down 90 may then occur. With regard to view 180, it appears that since a pattern may exist, a further investigation may include evaluating whether the pattern remains with higher-level data. In step 90, therefore, the additional data is added. FIG. 8 illustrates one representative view 190 from step 90, showing a table of both male and female policy size 192 versus issue age 194. The new view 190 is evaluated 92 as to whether this pattern remains at the higher level. If not, the new variable (“female,” in this example) is removed 94 and step 82 is repeated. If however the pattern remains, further processing may occur, as in step 96.

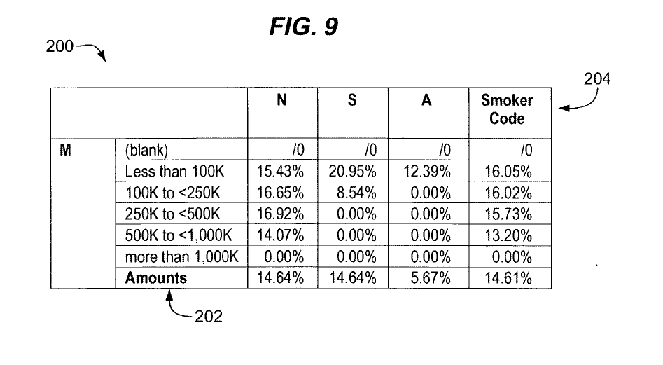

With regard to view 190, there does not appear to be a similar pattern for females as compared to male patterns. Therefore, the female variable is removed 94 and step 82 is repeated. If for example issue age is replaced by smoker code, step 82 may generate view 200 of FIG. 9. View 200 shows policy size 202 versus male smoker status 204. Once again, a pattern does not emerge and so step 82 may repeat.

Continued processing of variables may identify a noteworthy pattern in step 96. When noted, the data is again compared 98 to a higher-level variable and, if not the highest level, retested at step 90. Other variables may then be evaluated 100 in method 70, as shown.

Since certain changes may be made in the above methods and systems without departing from the scope of the invention, it is intended that all matter contained in the above description or shown in the accompanying drawing be interpreted as illustrative and not in a limiting sense. It is also to be understood that the following claims are to cover all generic and specific features of the invention described herein, and all statements of the scope of the invention which, as a matter of language, might be said to fall there between.

What is claimed is:

1. A process for determining preferred life mortality, comprising the steps of:
electronically synthesizing mortality data from a plurality of insurance carriers; and
automatically generating one or more interactive analyses of the mortality data in response to user inputs defining one or more preferred life risk scenarios.

2. A process of claim 1, the step of synthesizing mortality data comprising synthesizing information of multiple deaths or prior insured over a period of time.

3. A process of claim 2, the period of time comprising a plurality of years.

4. A process of claim 1, further comprising the step of electronically assessing adequacy of pricing for at least one insurance policy of at least one of the insurance carriers, based on the analyses.

5. A process of claim 1, further comprising the step of electronically assessing adequacy of monetary reserves of one of the insurance carriers, based on the analyses.

6. A process of claim 5, further comprising reporting the adequacy of the monetary reserves to at least one regulatory body.

7. A process of claim 5, the step of electronically assessing comprising synthesizing portfolio data from the one insurance carrier, the portfolio data comprising data of preferred risks.

8. A process of claim 1, the step of automatically generating comprising transforming the analyses into a data cube.

9. A process of claim 1, the step of automatically generating comprising graphically showing one or more of mortality, persistence and morbidity data based on the life risk scenarios.

10. A process of claim 9, the step of graphically showing comprising displaying a table of the analyses functionally dependent upon two of the life risk scenarios.

11. A process of claim 10, further comprising regenerating the table functionally dependent upon another two of the life risk scenarios in response to user inputs indicating the two life risk scenarios.

12. A process of claim 1, the step of automatically generating comprising generating the analyses based upon the life risk scenarios selected from the group consisting essentially of age, height, weight, gender, blood pressure, cholesterol, familial cancer history, familial history of heart attack, familial history of stroke, smoker or non-smoker status, and smoking history.

13. A process of claim 1, the step of automatically generating comprising synthesizing one or more benchmark tables to produce the analyses.

14. A process of claim 13, the step of synthesizing comprising synthesizing one or more of a 1975-1980 SOA mortality table, a 1980 CSO valuation table and a foreign actuarial table.

15. A process of claim 1, further comprising a step of electronically inputting policy information from the plurality of insurance carriers to a secure database.

16. A process of claim 15, the step of inputting comprising submitting the policy information periodically in bulk to the secure database.

17. A process of claim 15, the step of inputting comprising utilizing a network between the plurality of insurance carriers and the secure database.

18. A process of claim 1, the step of automatically generating one or more analyses comprising generating a comparison between at least two of the insurance carriers.

19. A process of claim 1, the step of automatically generating one or more analyses comprising generating a comparison between plan type having a duration over a term of years.

20. A process of claim 1, further comprising the steps of (a) automatically generating one or more client files in response to automatic download of the mortality data, (b) automatically converting the files according to business rules to ensure that the mortality data is uncorrupted and uniformly formatted, (c) automatically mapping policy-level demographic data into exposure calculations, and (d) transforming mapped exposure calculations into a data cube.

21. A process of claim 1, the step of automatically generating comprising the step of generating the analyses relative to one or more of study calendar year, study period, gender, issue age, type of underwriting, plan code, generic mortality code, policy duration, issued amount, benefit amount, active and inactive policies, start date of exposure, end date of exposure, end date of policy exposure, partial duration of calendar year, and active policy exposure calculations.

22. A process of claim 1, the step of automatically generating one or more analyses comprises presenting one or more of: exposure, in years; expected mortality based upon (exposure)×(mortality rate); variance based upon (exposure)×(mortality rate)×(1-mortality rate); and a ratio of actual mortality versus expected mortality.

23. A system for determining preferred life mortality, comprising:
a secure database for storing policy-level demographic data of individual insured lives, the data deriving from two or more insurance carriers and being normalized to one or more classifications of risk; and
a software application for synthesizing the data to generate one or more analyses of the data in response to user inputs at a computer networked with the secure database.

24. A system of claim 23, the user inputs comprising one or more preferred life risk scenarios.

25. A system of claim 24, the user inputs comprising two preferred life risk scenarios selected from the group consisting essentially of age, height, weight, blood pressure, cholesterol, familial cancer history, familial history of heart attack, gender, familial history of stroke, smoker or non-smoker status, and smoking history.

26. A system of claim 23, the secure database storing industry standard benchmark tables, the software application generating the analyses based in part on the tables.

27. A system of claim 26, the benchmark tables comprising one or more of a 1975-1980 SOA mortality table, a 1980 CSO valuation table and a foreign actuarial table.

28. A system of claim 23, further comprising a web platform for accessing the secure database through the Internet, the web platform presenting the analyses to the computer connected with the Internet in response to the user inputs at the computer.

29. A system of claim 23, the application software comprising analytical tools for generating a graphical user interface presenting the analyses.

30. A system of claim 29, the analytical tools generating a data cube of the analyses.

31. A system of claim 23, further comprising a data flow engine operatively coupled with the secure database to facilitate automatic download of the policy-level demographic data, from the plurality of insurance carriers, to the secure database.

32. A system of claim 31, the data flow engine having (a) means for generating one or more client files in response to automatic download of the policy-level demographic data, (b) means for converting the files according to business rules to ensure that the policy-level demographic data is uncorrupted and uniformly formatted, (c) means for mapping policy-level demographic data into exposure calculations, and (d) means for transforming mapped exposure calculations into a data cube of the analyses.

33. A system of claim 23, further comprising means for generating the analyses relative to one or more of study calendar year, study period, gender, issue age, type of underwriting, plan code, generic mortality code, policy duration, issued amount, benefit amount, active and inactive policies, start date of exposure, end date of exposure, end date of policy exposure, partial duration of calendar year, and active policy exposure calculations.

34. A system of claim 23, further comprising means for generating the analyses by presenting one or more of: exposure, in years; expected mortality based upon (exposure)×(mortality rate); variance based upon (exposure)×(mortality rate)×(1-mortality rate); and a ratio of actual mortality versus expected mortality.

35. An interactive system for presenting synthesized preferred life mortality data to computers networked thereto, comprising:
means for inputting and storing mortality data from a plurality of insurance carriers; and
means for processing the data with one or more actuarial tables to interactively and graphically generate analyses relative to user selected life risk scenarios.

36. A system of claim 35, the life risk scenarios selected from the group consisting essentially of age, height, weight, blood pressure, cholesterol, familial cancer history, familial history of heart attack, gender, familial history of stroke, smoker or non-smoker status, and smoking history, the actuarial tables comprising benchmark tables.
